(19) United States
(12) Patent Application Publication
(10) Pub. No.: US 2003/0130781 A1
(43) Pub. Date: Jul. 10, 2003

(54) Anti-lock braking system (ABS) for vehicles with an additional axle

(76) Inventors: Herbert Schramm, Leonhard (DE); Werner Stumpe, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/307,492

(22) Filed: Dec. 2, 2002

Related U.S. Application Data
(63) Continuation of application No. PCT/EP01/05642, filed on May 17, 2001.

(30) Foreign Application Priority Data
May 30, 2000 (DE) 100 26 689.4

(51) Int. Cl. B60T 8/32

(52) U.S. Cl. 701/71; 303/121

(57) ABSTRACT

Control of an ABS of an axle-assembly, formed by a principal axle and one or more additional axles, is provided to achieve this control the wheel speed behavior sensors located on the principal axle of the axle-assembly are used exclusively for monitoring the wheel speed behavior.

### CROSS REFERENCE TO RELATED APPLICATIONS

This application is a continuation of PCT international application no. PCT/EP01/05642, filed May 17, 2001, and claims priority based on German patent application no. DE 100 26 689.4, filed May 30, 2000, the specifications of which are incorporated by reference herein.

### BACKGROUND AND SUMMARY OF THE INVENTION

The present invention relates to an anti-lock braking system (ABS) for vehicles having an additional axle.

In the case of heavy commercial or utility vehicles, in addition to having a front axle and a rear axle, a third or “additional axle” is frequently provided. The additional axle forms a principal axle; that is, an “axle assembly” together with the front axle or with the rear axle. The additional axle may be arranged in front of or behind the principal axle. In the case of some vehicles, the additional axle can be raised and then lowered downwardly for use only when heavy loads are present. This is done in order to reduce the stressing of the assigned principal axle.

For some time, standard constructions of modern utility vehicles have been equipped with an ABS system. From the applicant's internal state of the art, ABS braking systems for vehicles with an additional axle are also known, in which case the brake pressures at the additional axle are controlled corresponding to the rotational wheel speed behavior of the additional axle. In the case of brake systems for vehicles with more than two axles, in which all axles are ABS-controlled, the number of required rotational wheel speed sensors, ABS-valves, etc. increases, which likewise increases the corresponding costs.

It is an object of the invention to provide an ABS brake system for vehicles with more than two axles which is cost-effective and has a low number of individual components.

This object is achieved by providing an ABS braking system for vehicles, particularly commercial or utility vehicles which have a first axle, a second axle and at least one additional axle. The system includes:

a) a service brake valve for defining a braking demand by the driver,

b) rotational wheel speed sensors arranged on the first axle for sensing the rotational wheel speed behavior at the first axle,

c) brake valves which are provided for an admission of brake pressure, for an individual axle or individual wheel, to brakes of the first axle and of the additional axle respectively, and

d) an ABS electronic system for monitoring the rotational wheel speed behavior at the first axle and for limiting the brake pressure defined by the driver for the brake valves of the first axle and the additional axle, respectively, in the event of an occurrence of a tendency to lock, the ABS electronic system detecting a tendency to lock at the first axle and/or at the additional axle exclusively by using the rotational wheel speed signals which are supplied by the rotational wheel speed sensors of the first axle. Advantageous developments and further developments of the invention are described herein.

The basic principle of the invention consists of using, for the ABS-control of an “axle assembly”, which is formed by a principal axle and one or more additional axles, only the rotational wheel speed sensors arranged on the principal axle of the axle assembly for monitoring the rotational wheel speed behavior.

When a tendency to lock exists at the principal axle, it is assumed that conditions requiring a control intervention also exist at the additional axle. In contrast to conventional ABS systems, in which case a separate rotational wheel speed sensor is required at each wheel, according to the invention, no separate rotational wheel speed sensors have to be provided at the wheels of the additional axle. This results in cost advantages. Nevertheless, the brake pressures at the principal axle and at the additional axle can be adapted to the respective existing coefficient-of-adhesion conditions at the axle assembly.

The reason is that in each case at least one brake valve is assigned to the axles of the axle assembly, which brake valve permits a brake pressure control for an individual axle or individual wheel. A different brake pressure can therefore be apportioned to the additional axle than to the brakes of the principal axle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a first embodiment of the invention;

FIG. 2 is a schematic view of a second embodiment of the invention; and

FIG. 3 is a schematic view of a third embodiment of the invention.

### DETAILED DESCRIPTION OF THE DRAWINGS

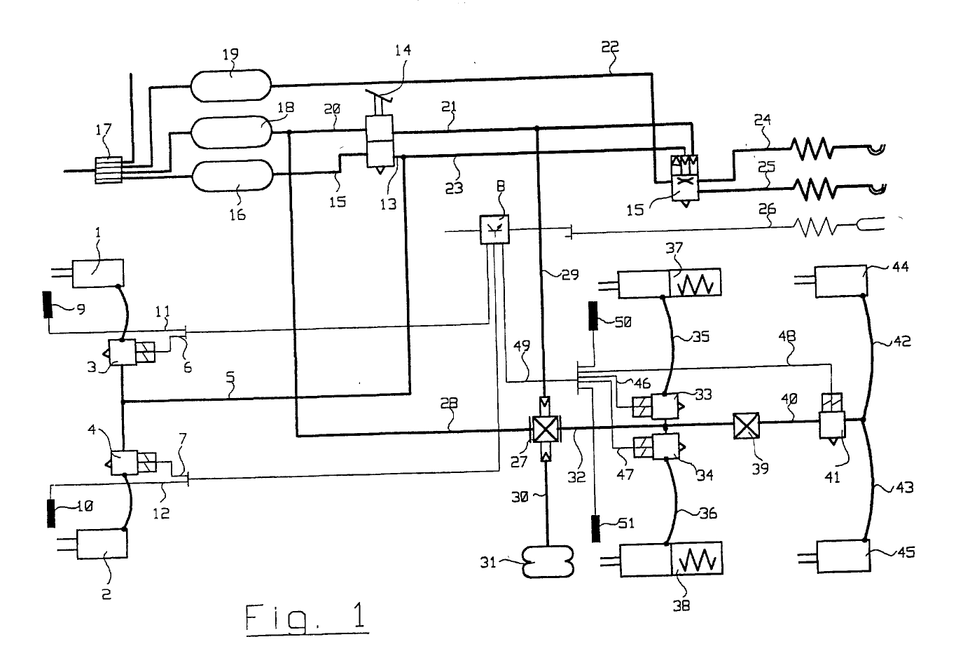

FIG. 1 illustrates a braking system according to a first embodiment of the invention. The braking system has front wheel brake cylinders 1, 2, which are connected with a brake line 5 by way of ABS-valves 3, 4. The ABS-valves 3, 4 are connected by way of electrical control lines 6, 7 with an electronic control system 8. Rotational wheel speed sensors 9, 10, which are connected with the electronic control system 8 by way of corresponding electrical lines 11, 12, are assigned to the front wheels (not shown).

The brake line 5 is connected to an output-side connection device 13 of a foot brake valve 14 to be operated by the driver. An input-side connection device 15 assigned to the connection device 13 is connected by way of a first compressed-air reservoir 16 with a distributor valve 17. The distributor valve 17 is supplied with compressed air by a compressor (not shown). In addition, a second compressed-air reservoir 18 and a third compressed-air reservoir 19 are connected to the distributor valve 17. By way of pneumatic lines 20, 21 and the foot brake valve 14, the second compressed-air reservoir 18 is connected with a trailer control valve 15. The trailer control valve 15 is connected by way of a pneumatic line 22 with the third compressed-air reservoir 19 and by way of a pneumatic line 23 with the connection device 13 of the foot brake valve 14. In addition, the trailer control valve 15 can be connected by way of pneumatic lines 24, 25 with the braking system of a trailer (not shown). Furthermore, an electrical connection line 26, which is connected with the electronic control system 8, is provided for the trailer.

In addition, a pressure reducing valve 27 is provided, which is connected with the second compressed-air reservoir 18 by way of a supply line 28. Furthermore, the pressure reducing valve 27 is connected by way of a first pneumatic control line 29 with the pneumatic line 21 and by way of a second pneumatic control line 30 with a load sensor 31. The load sensor 31 supplies a control signal corresponding to the rear axle load.

From the pressure reducing valve 27, a pneumatic line 32 leads to the rear axle ABS-valves 33, 34, which are connected by way of brake lines 35, 36 with assigned rear axle brake cylinders 37, 38.

The pneumatic line 32 continues to a pressure reducing valve 39, which is connected by way of a pneumatic line 40 with an ABS-valve 41. From the ABS-valve 41, brake lines 42, 43 lead to brake cylinders 44, 45 of an additional axle. The rear axle and the additional axle together form an “axle assembly”.

By way of assigned electrical control lines 46, 47, 48, 49, the ABS-valves 33, 34 and 41 are connected with the electronic control system 8. Furthermore, rotational wheel speed sensors 50, 51, which are also connected with the electronic control system 8, are assigned to the rear wheels (not shown).

During a normal service braking, the driver defines a braking demand signal for the front wheel brake cylinders 1, 2 by way of the service brake valve 14 or the brake line 5. By way of the brake valve 14 or the pneumatic control line 29 and the pressure reducing valve 27, a brake pressure is defined for the rear axle brake cylinders 37, 38. By way of the pressure reducing valve 39, brake pressure will reach the ABS-valve 41 or the brake cylinders 44, 45, in which case the brake pressure for the additional axle may be lower than the brake pressure supplied to the rear axle ABS-valves 33, 34 corresponding to the pressure reduction by the pressure reducing valve 39.

In the case of an excessive braking demand or in the event of poor coefficients of adhesion between the tires and the road, the rotational wheel speed sensors 50, 51 will detect a tendency to lock at one or at both wheels of the rear axle. In this case, the rotational wheel speed signals are monitored by the electronic control system 8. The electronic control system 8 controls the ABS-valves 33, 34 of the rear axle and the ABS-valve 41 of the additional axle, whereby the brake pressures are correspondingly controlled at the rear axle brake cylinders 37, 38 and at the brake cylinders 44, 45 of the additional axle respectively. When the ABS-control starts at a wheel of the rear axle, a pressure control simultaneously takes place at the additional axle; that is, a synchronous ABS-control cycle takes place. In this embodiment, the ABS pressure control of the additional axle can take place only by a time-controlled program and is fairly roughly adapted to the principal axle, that is, to the rear axle, because no signal feedback takes place from the additional axle.

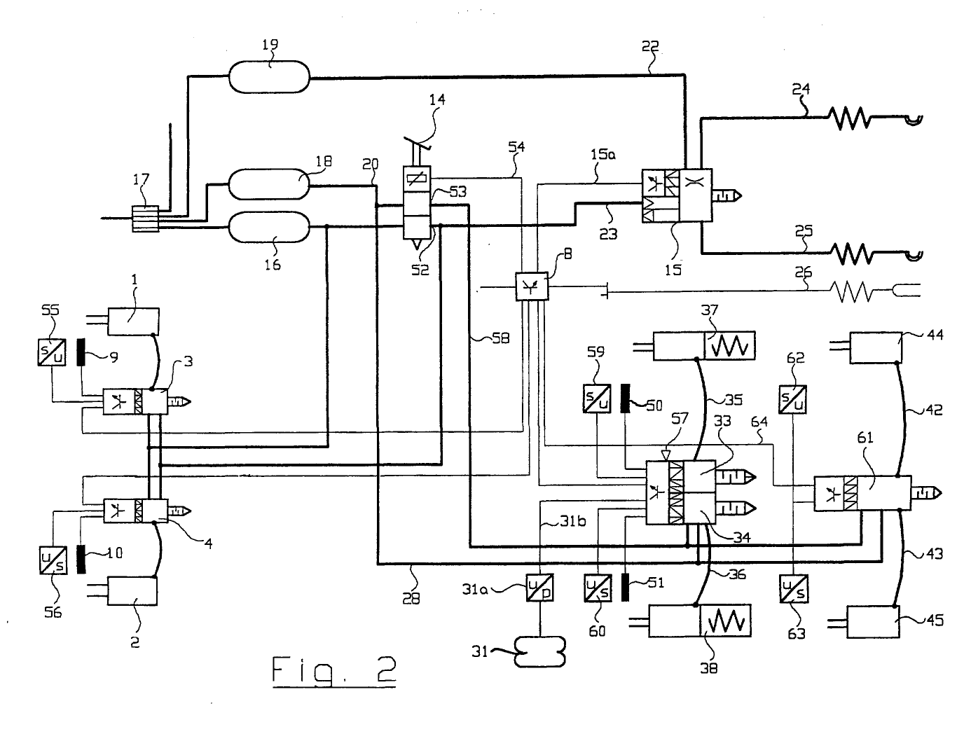

A finer ABS-control is possible by means of an electronically controlled braking system (EBS), which will be explained in detail in connection with FIG. 2.

FIG. 2 illustrates an embodiment of an electronically controlled braking system (EBS) according to the invention. Corresponding to the embodiment of FIG. 1, the foot brake valve 14 has pneumatic control outputs 52, 53 as well as an electrical control output 54, which is connected with the electronic control system 8. Analogous to FIG. 1, the electronic control system 8 is connected with the ABS-valves 3, 4 of the front axle, in which case the rotational wheel speed sensors 9, 10 are directly connected to the ABS-valves 3, 4. Additionally, brake lining wear sensors 55, 56 are provided, which are also connected to the ABS valves 3,4. Here, the two ABS-valves 33, 34 of the rear axle are combined to form an electropneumatic pressure control module 57 which is connected by way of the pneumatic supply line 28 with the second compressed-air reservoir 18 and by way of a pneumatic line 58 with the output 53 of the foot brake valve 14. The rotational wheel speed sensors 50 and 51 are connected to an electrical input of the electropneumatic pressure control module 57. In contrast to FIG. 1, here, also the load sensor 31 is connected by means of a pressure/voltage converter 31 by way of an electric line 31b with the pressure control module 57. Brake lining wear sensors 59, 60, which are assigned to the rear axle brakes, are also connected with the pressure control module 57. A pressure control module 61, which is assigned to the brake cylinders 44, 45 of the additional axle, are connected to the pneumatic lines 28 and 58 respectively. Here, brake lining wear sensors 62, 63, which are connected to the pressure control module 61, are also assigned to the brake cylinders 44, 45. Further, an electric line 64 is provided which connects the pressure control module 61 with the electronic control system 8.

The pressure control module 61 of the additional axle has an integrated pressure feedback. When a tendency to lock is detected by the rotational wheel speed sensors 50, 51 of the rear axle, a desired pressure value is fed to the pressure control module 61 of the additional axle by way of the electric line 64 by the electronic control system 8. This desired pressure value follows the “ABS pressure course” of the rear axle, that is, the ABS pressure course of the brake cylinders 37, 38. As a result of the integrated pressure feedback, the pressure control of the additional axle can better follow the pressure control at the wheels of the rear axle. When the ABS responds, the pressure value for the pressure control module 61 of the additional axle can be based on different control criteria:

1. The desired pressure value can be controlled corresponding to the “low wheel” of the rear axle; that is, the desired pressure value is set as a function of the brake pressure at that wheel of the rear axle which has the lower rotational speed.

2. The desired pressure value is set corresponding to the brake pressure of the “high wheel” of the rear axle; that is, corresponding to the brake pressure of the wheel of the rear axle with the higher rotational speed.

3. The desired pressure value is set as a function of both brake pressures of the rear axle.

Depending on which control concept is used for the desired pressure value, a partial locking of a wheel of the additional axle is accepted.

For reasons of completeness, it should be mentioned that, in the embodiment of FIG. 2, the trailer control valve 15 is connected by way of an electrical control line 15a with the electronic control system 8 and by way of the pneumatic line 23 with the foot brake valve 14.

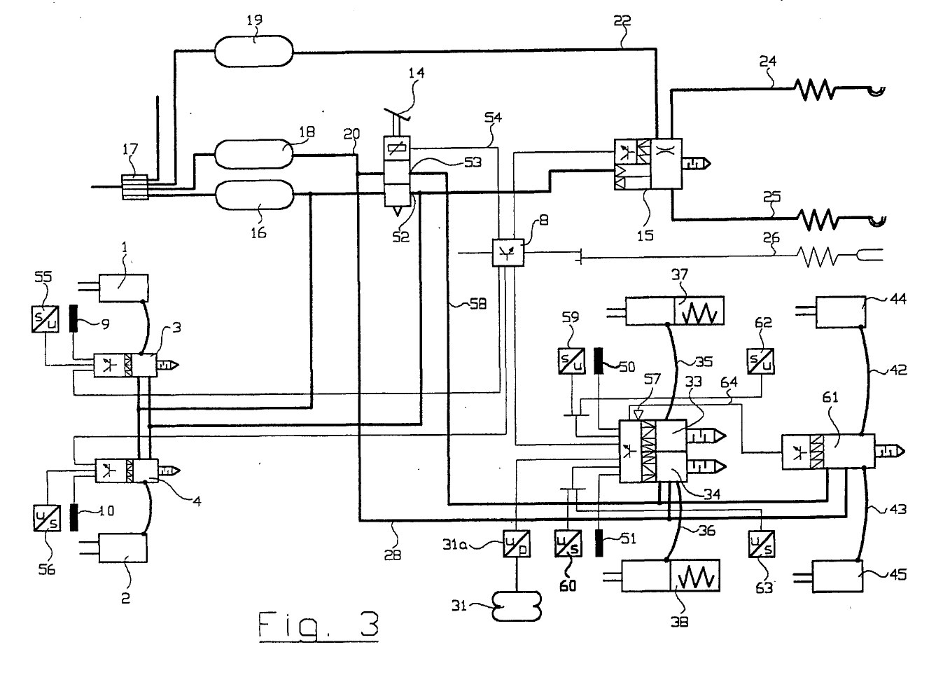

FIG. 3 shows a variant of the embodiment of FIG. 2. In FIG. 3, the pressure control module 61 of the additional axle is connected by way of the electrical line 64 with the pressure control module 57 of the rear axle. Here, the desired pressure value for the pressure control module 61 is supplied by the pressure control module 57 of the rear axle. In contrast to FIG. 2, here the brake lining wear sensors 62, 63 of the additional axle are connected to the pressure control module 57 of the rear axle. This allows for an actuator to be provided at the additional axle which has fewer electronic devices.

The embodiments described in FIGS. 1 to 3 can also be expanded to a four-axle vehicle. Furthermore, as an alternative to the illustrated embodiments, the additional axle may also be arranged in front of the rear axle or two additional axles may be assigned to the rear axle. A variant is also contemplated in the case of which an additional axle is in each case assigned to the front axle as well as to the rear axle.

By means of the invention, an individual brake pressure control of the additional axle is possible. During normal brakings below the “locking limit”; that is, during brakings in which the ABS system does not respond, a different brake pressure may be apportioned to the additional axle than to the principal axle. An important advantage is the fact that rotational wheel speed sensors at the additional axle are not required. Nevertheless, the additional axle is protected from a complete locking because, in the case of an ABS-intervention at the principal axle, the additional axle receives a corresponding “desired ABS value”.

The simplified term “brake pressure control” mentioned above applies to all brake pressure apportioning methods with a corresponding sensing, for example, with respect to the braking force, the braking torque, the wheel speed, the wheel deceleration, the brake slip, etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An ABS braking system for vehicles having a first axle, a second axle and at least one additional axle, the system comprising:
a) a service brake valve for defining a braking demand by a driver,
b) rotational wheel speed sensors arranged on the first axle for sensing a rotational wheel speed behavior at the first axle,
c) brake valves provided for an admission of brake pressure for an individual axle or individual wheel assigned to brakes of the first axle and of the additional axle, respectively, and
d) an ABS electronic system for monitoring the rotational wheel speed behavior at the first axle and for limiting a brake pressure defined by the driver for the brake valves of the first axle and the additional axle, respectively, in an event of an occurrence of a tendency to lock; wherein the ABS electronic system detects a tendency to lock at at least one of the first axle and the additional axle exclusively via rotational wheel speed signals supplied by the rotational wheel speed sensors of the first axle.

2. The ABS braking system according to claim 1, wherein of the brake valves, a separate brake valve is in each case assigned to brakes of the rear axle for admitting brake pressure to an individual wheel.

3. The ABS braking system according to claim 1, wherein of the brake valves, a common brake valve is assigned to brakes of the additional axle.

4. The ABS braking system according to claim 2, wherein of the brake valves, a common brake valve is assigned to brakes of the additional axle.

5. The ABS braking system according to claim 1, wherein the brake valve of the additional axle is connected by way of a control line with the ABS electronic system of the first axle.

6. The ABS braking system according to claim 2, wherein the brake valve of the additional axle is connected by way of a control line with the ABS electronic system of the first axle.

7. The ABS braking system according to claim 3, wherein the brake valve of the additional axle is connected by way of a control line with the ABS electronic system of the first axle.

8. The ABS braking system according to claim 1, wherein the brake valve of the additional axle is a pressure control module to which a brake pressure sensor is assigned for sensing a brake pressure signal of the additional axle, the brake pressure sensor being connected with the ABS electronic system.

9. The ABS braking system according to claim 2, wherein the brake valve of the additional axle is a pressure control module to which a brake pressure sensor is assigned for sensing a brake pressure signal of the additional axle, the brake pressure sensor being connected with the ABS electronic system.

10. The ABS braking system according to claim 3, wherein the brake valve of the additional axle is a pressure control module to which a brake pressure sensor is assigned for sensing a brake pressure signal of the additional axle, the brake pressure sensor being connected with the ABS electronic system.

11. The ABS braking system according to claim 8, wherein a desired brake pressure value is supplied to the pressure control module of the additional axle by the ABS electronic system, which desired brake pressure value follows a desired brake pressure course for the rear axle.

12. The ABS braking system according to claim 9, wherein a desired brake pressure value is supplied to the pressure control module of the additional axle by the ABS electronic system, which desired brake pressure value follows a desired brake pressure course for the rear axle.

13. The ABS braking system according to claim 10, wherein a desired brake pressure value is supplied to the pressure control module of the additional axle by the ABS electronic system, which desired brake pressure value follows a desired brake pressure course for the rear axle.

14. The ABS braking system according to claim 11, wherein the desired brake pressure is selected as a function of the brake pressure of the brake of that wheel of the rear axle which has a higher or a lower rotational wheel speed.

15. The ABS braking system according to claim 12, wherein the desired brake pressure is selected as a function of the brake pressure of the brake of that wheel of the rear axle which has a higher or a lower rotational wheel speed.

16. The ABS braking system according to claim 13, wherein the desired brake pressure is selected as a function of the brake pressure of the brake of that wheel of the rear axle which has a higher or a lower rotational wheel speed.

17. The ABS braking system according to claim 8, wherein the desired brake pressure is selected as a function of the brake pressures of both rear axle brakes.

18. The ABS braking system according to claim 12, wherein the desired brake pressure is selected as a function of the brake pressures of both rear axle brakes.

19. The ABS braking system according to claim 13, wherein the desired brake pressure is selected as a function of the brake pressures of both rear axle brakes.

20. The ABS braking system according to claim 8, wherein the pressure control module of the additional axle is connected by way of an electrical line with the pressure control module of the rear axle.

21. The ABS braking system according to claim 18, wherein the pressure control module of the additional axle is connected by way of an electrical line with the pressure control module of the rear axle.

22. The ABS braking system according to claim 19, wherein the pressure control module of the additional axle is connected by way of an electrical line with the pressure control module of the rear axle.

23. The ABS braking system according to claim 1, wherein the vehicle is a utility vehicle.

24. An ABS braking system for a vehicle having a first axle, a second axle and at least one additional axle, the system comprising:
rotational wheel speed sensors arranged on the first axle for sensing rotational wheel speeds at the first axle;
an ABS electronic system receiving the rotational wheel speeds from the rotational wheel speed sensors and monitoring rotational wheel speed behavior at the first axle, the ABS electronic system limiting a braking demand defined by a driver for the first axle and the additional axle in an event of a locking tendency; and
wherein the ABS electronic system detects the locking tendency at at least one of the first axle and the additional axle exclusively via the rotational wheel speeds supplied by the rotational wheel speed sensors arranged on the first axle.

25. A method of operating an ABS braking system for a vehicle having a first axle, a second axle and at least one additional axle, the method comprising the acts of:
detecting a wheel locking tendency at at least one of the first axle and the additional axle exclusively via rotational wheel speed signals supplied by rotational wheel speed sensors arranged on the first axle; and
limiting a brake pressure defined by a driver for brake valves of the first axle and the additional axle when the wheel locking tendency is detected.
